(19) United States
(12) Patent Application Publication
(10) Pub. No.: US 2018/0318744 A1
(43) Pub. Date: Nov. 8, 2018

(54) HORIZONTAL ELONGATED INDUSTRIAL AIR FILTER

(71) Applicant: RoboVent Products Group, Inc., Sterling Heights, MI (US)

(72) Inventors: John Reid, Troy, MI (US); James Reid, Blacklick, OH (US); Michael Hattingh, Troy, MI (US)

(21) Appl. No.: 15/971,756

(22) Filed: May 4, 2018

Related U.S. Application Data
(60) Provisional application No. 62/502,377, filed on May 5, 2017.

(51) Int. Cl. B01D 46/00

(52) U.S. Cl. CPC B01D 46/0093; B23K 37/006; B01D 46/0047; B01D 46/0005

(57) ABSTRACT

A horizontal elongated industrial air filter having an elongated housing. The housing has a filter section with an intake and an exhaust. The housing has filter media in operative communication with the intake. Mounted adjacent the filter media is a blower to pull air into the intake through the filters and push the air out of the exhaust. Reverse pulse pipes extend through the interiors of the filter media to inject air through the filter to remove accumulated particulate. A hopper containment section extends below the filter housing section, and includes a plurality of spaced slots extending through its bottom to receive particulate ejected from said filter media. Connected to the hopper containment section is a vacuum channel to pull particulate in the hopper containment section through the slots. Mounted to the housing is a spark arrestor. The spark arrestor has an outer shell, an inlet and an inner duct with the outer shell spaced from the inner duct to define a tortuous path. The blower draws air with particulates into the inlet and forces it along the tortuous path with the particulates colliding against the shell and inner duct.

### RELATED APPLICATIONS

This application claims the benefit of U.S. Provisional Application Ser. No. 62/502,377, filed May 5, 2017, which is incorporated herein by reference in its entirety.

### STATEMENT REGARDING FEDERALLY SPONSORED RESEARCH

NONE.

### TECHNICAL FIELD

This invention relates generally to industrial air filters.

### BACKGROUND OF THE INVENTION

The present invention generally relates to industrial air filters and more particularly to industrial air filters mounted to the ceiling structure of a workspace, such as a factory. Typically, air filters are mounted on the floor adjacent to the work being performed. The disadvantage is that the air filter occupies valuable floor space and can obstruct normal workflow. Additionally, the floor mounted air filters have to be moved in the event the workspace needs to be moved. A still further problem is the air filter has to be directly connected to the workspace. This inhibits the filtering of the general air within the facility. A further problem is that the air to be filtered is normally hot air and rises.

The present invention overcomes these problems since it is mounted to the ceiling of the facility. The air filter captures the hot air as it rises and the general air within the facility. It also does not obstruct the floor space.

### SUMMARY OF THE INVENTION

In general terms, this invention provides a horizontal elongated industrial air filter having an elongated housing. The air filter is mounted to the ceiling of a work area. The housing has a filter section with an intake and an exhaust. The housing has filter media in operative communication with the intake. Mounted adjacent the filter media is a blower to pull air into the intake through the filters and push the air out of the exhaust.

Reverse pulse pipes extending through the interiors of the filter media inject air through the filter to remove accumulated particulate. A hopper containment section extends below the filter housing section, and includes a plurality of spaced slots extending through its bottom to receive particulate ejected from the filter media. Connected to the hopper containment section is a vacuum channel to pull particulate in the hopper containment section through the slots.

Mounted to the housing is a spark arrestor. The spark arrestor has an outer shell, an inlet and an inner duct with the outer shell spaced from the inner duct to define a tortuous path. The blower draws air with particulates into the inlet and forces it along the tortuous path with the particulates colliding against the shell and inner duct.

The horizontal elongated industrial air filter of the present invention provides the benefit of being mounted to the ceiling of a facility to free up floor space. Additionally, the horizontal elongated industrial air filter is located in the optimum location, since hot air rises and this facilitates capturing the air with entrained particulates by the air filter.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a side view of the back of the horizontal elongated industrial air filter of the present invention.

FIG. 2 is a partial perspective view of the front of the horizontal elongated industrial air filter.

FIG. 3 is a cutaway side view of the horizontal elongated industrial air filter of the present invention.

FIG. 4 is an exploded view of section B of FIG. 3.

FIG. 5 is a side view of the front of the horizontal elongated industrial air filter of the present invention.

FIG. 6 is an end view of the horizontal elongated industrial air filter of the present invention.

FIG. 7 is a cutaway view taken along line 7-7 in FIG. 5.

FIG. 8 is a cutaway view taken along line 8-8 in FIG. 6.

FIG. 9 is an enlarged view of area B in FIG. 7.

FIG. 10 is a perspective view of the front of the spark arrestor of the present invention.

FIG. 11 is a perspective view of the back of the spark arrestor of the present invention.

FIG. 12 is a cross section of the horizontal elongated industrial air filter of the present invention.

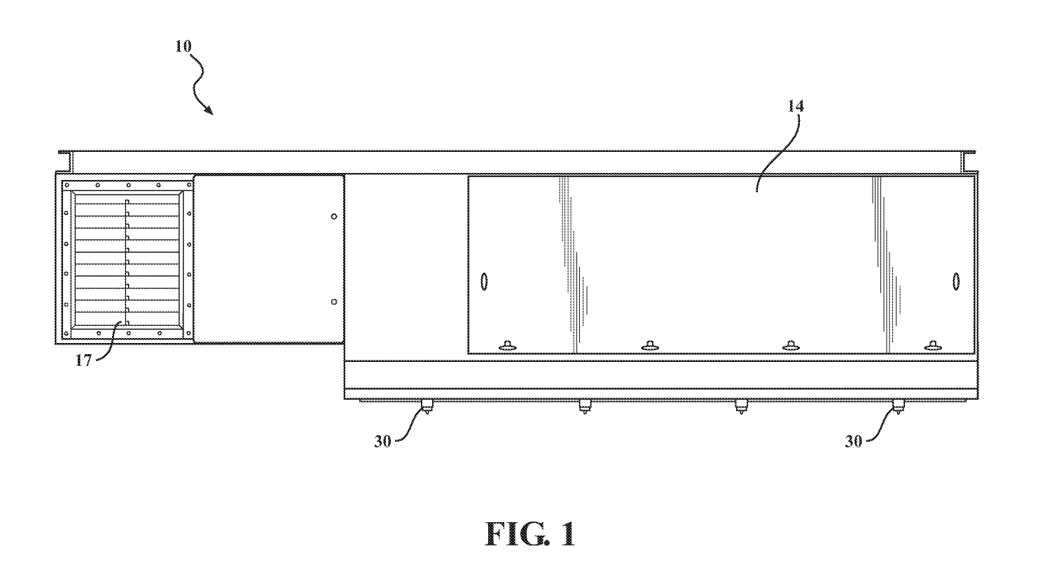

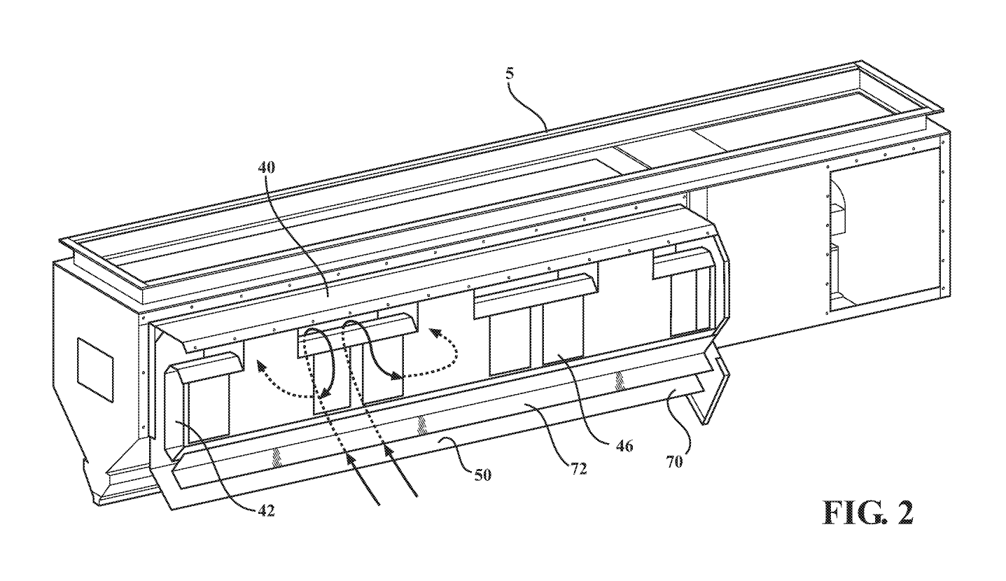

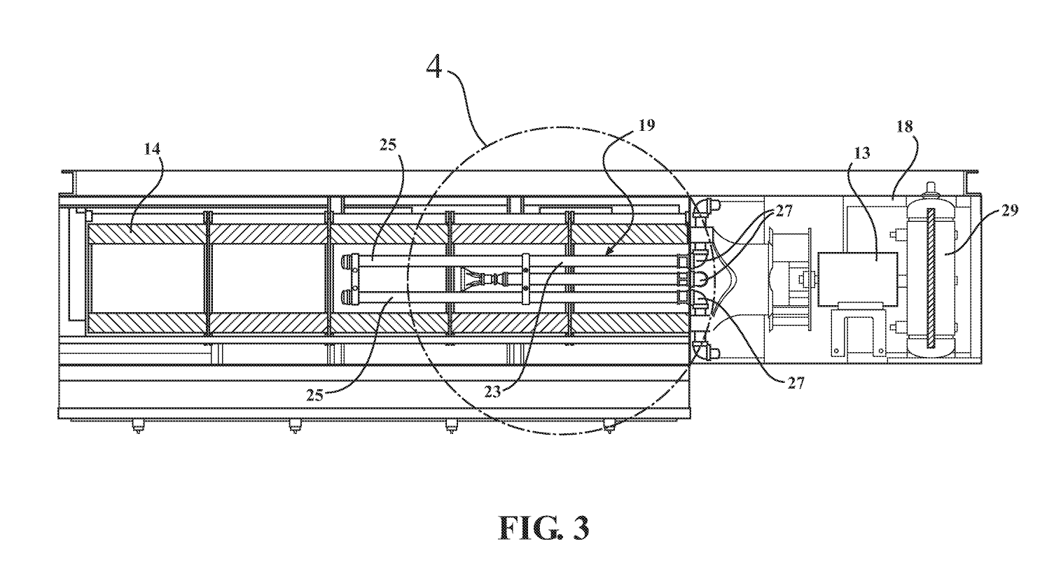

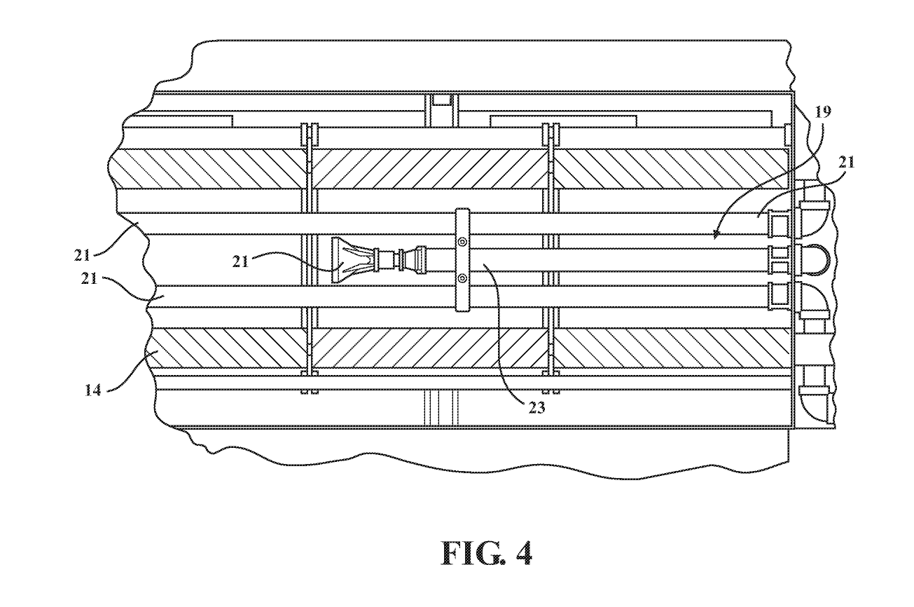

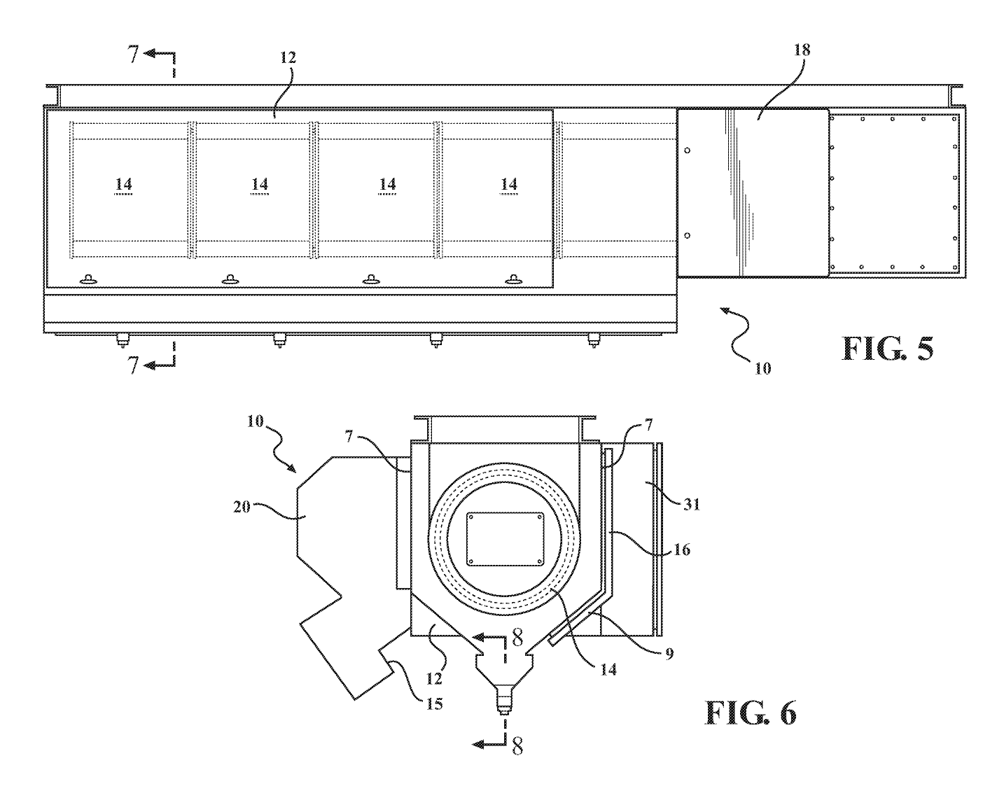

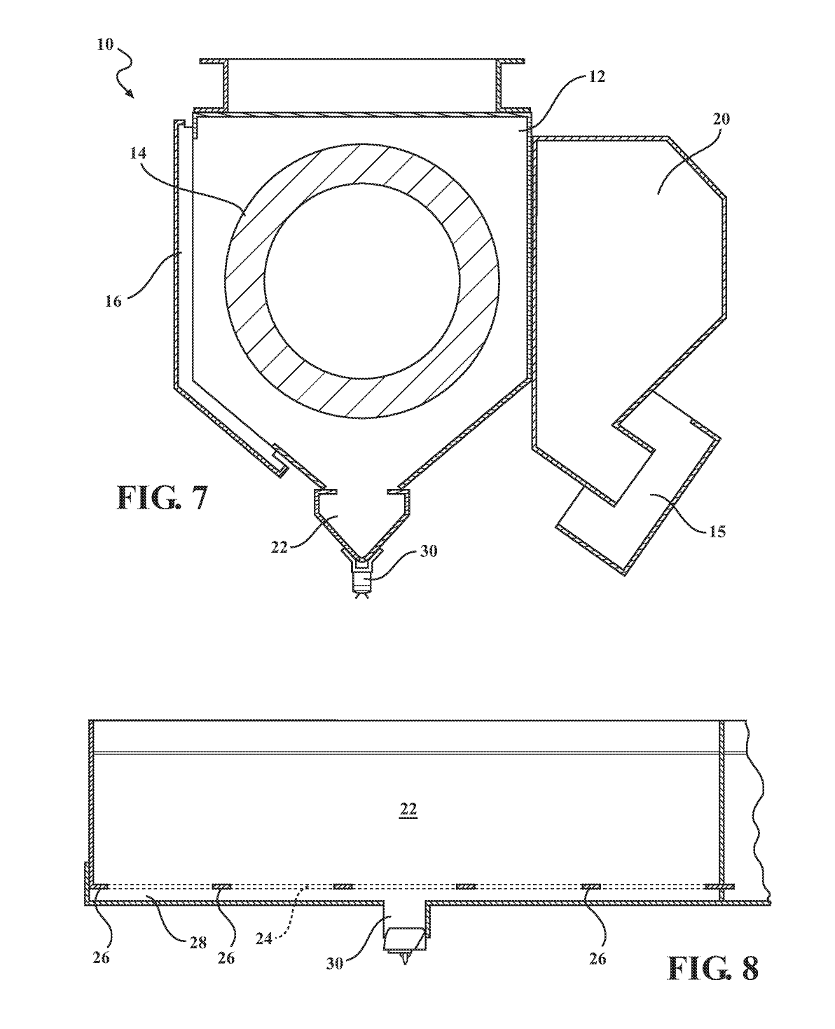

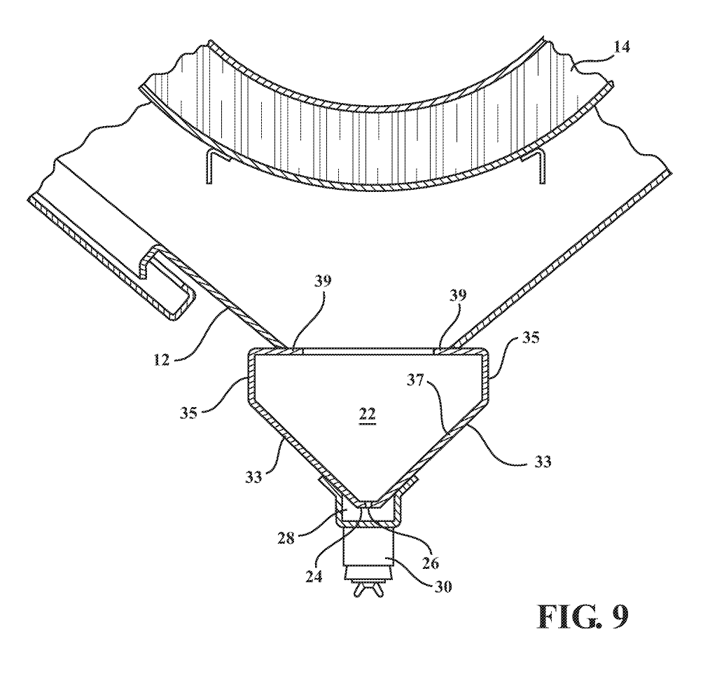

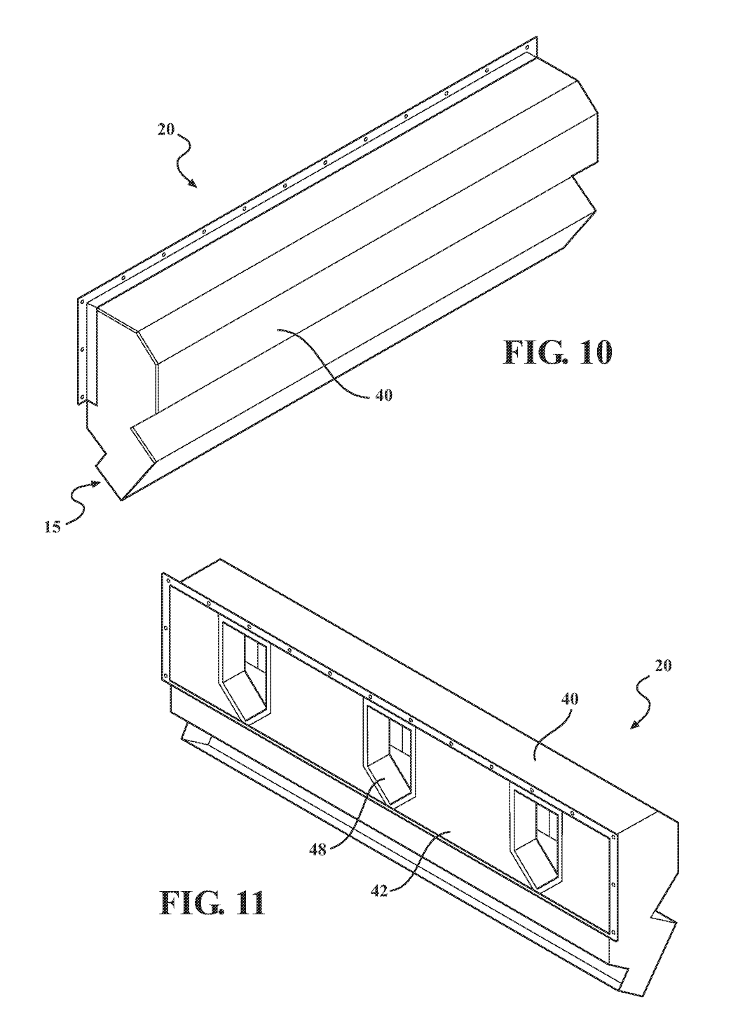

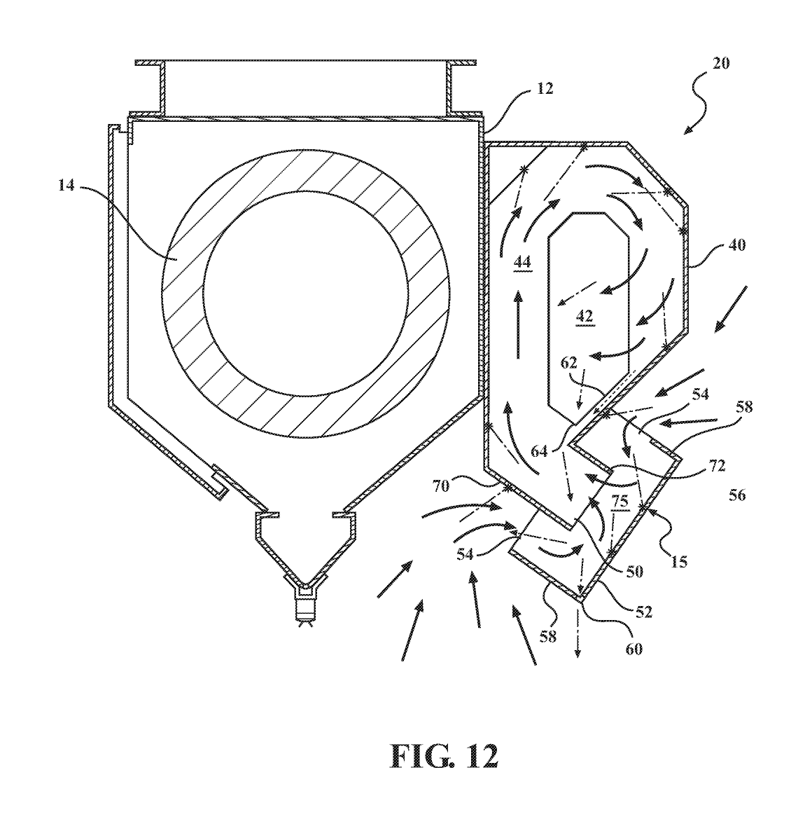

### DETAILED DESCRIPTION OF A PREFERRED EMBODIMENT

The present invention relates to an industrial air filter unit for filtering air within an industrial environment, such as for example, a manufacturing facility, a welding station, grinding center, etc. The present air filter is generally shown at 10. The air filter 10 has an elongated horizontally extending housing 12 containing a plurality of filter media 14. The housing is about 165 inches long 35 inches wide and 46 inches tall. The housing 12 has an upper section 7 with generally straight walls and a lower section 9 with angled walls. The filters 14 of the disclosed embodiment are cylindrical with an exterior and interior surface. In the disclosed invention, there are four filters 14. A filter door 16 provides access to the filter 14. The housing has connectors 5 along the top to fasten the air filter 10 to the ceiling of a factory.

A blower motor and blower fan 13 are mounted in the blower section 18 adjacent the filters 14 to pull air into the housing 12 though an intake 15 and through the filter media 14. The blower motor and fan 13 then pushes the air out of the exhaust 17.

The filter media 14 captures particulate entrained in the air as air is pulled through the filter. Air is pulled through the exterior of the filter 14 and then exits the air filter 14 from the core or interior of the filter. The filtered air is exhausted from the housing 12 through an exhaust 17.

In the disclosed embodiment, a spark arrestor 20 is provided adjacent the intake 15. The spark arrestor 20 provides a tortuous path for the air to reduce the potential for sparks entering the housing and contacting the filter. A spark arrestor is particularly important with filters used in, for example, welding, cutting and grinding operations.

After a period of operation, the filters 14 accumulate particulates. This can adversely affect operation of the filter. This period can be determined by either elapsed time, visual inspection or by flow sensors. High-pressure air is reverse pulsed into the filters to blow particulate off the filters 14. Pipes 19 extend into the core of the filters 14 with nozzles 21 attached to their ends to blow high-pressure air against the inside of the filters 14. In the disclosed embodiment, the pipes 19 extend to different positions within the filters. A first pipe 23 extends a little less than a third of the way, and the other two pipes 25 extend about two thirds of the way into the filter media 14. The first pipe 23 is shown with a wide-angle nozzle 21 and the other two pipes 25 are illustrated with a plurality of spaced nozzles down the length of the pipes 25. The spaced nozzles 21 can be simply drilled holes in the pipes 25. Those of ordinary skill in the art will understand that you can use other pipe arrangements. Three connections 27 connect the pipes 23 and 25 to a high-pressure air reservoir 29. Compressed air outlets found with in a manufacturing facility or an onboard compressor provide the high-pressure air.

Controls, such as solenoid valves connected to timers or a pc control system 31 control the operation of the pipes 23 and 25 to pulse air into the filters 14. The pulsed air blows particulate off the filters into the hopper containment section 22. The particulate accumulates in the containment section 22. The containment section has V-shaped walls 33 and a relatively narrow bottom 24. A plurality of spaced slots 26 extend along the length of the bottom 24 of the containment section 22. In the disclosed embodiment, the containment section also includes upper walls 35 with an opening 37 partially closed by flanges 39. The opening 37 is in fluid communication with the filter section of housing 12.

A narrow elongated vacuum channel 28 extends below the bottom 24 of the containment section 22. The vacuum channel 28 has a plurality of vacuum ports 30. A vacuum hose is connected to the ports 30 to create a vacuum along the vacuum channel 28. The vacuum in the vacuum channel 28 sucks the particulate in the containment section 22 through the slots 26 to clean out the accumulated particulate. A vacuum cleaner is typically used to create the vacuum and vacuum out the particulate.

The spark arrestor 20 is mounted to the housing 12. Spark arrestor 20 has an outer shell 40, intake 15 and an inner duct 42. The outer shell 40 is spaced from the inner duct 42 to define a tortuous path 44. The blower 13 draws air containing particulates into the intake 15 and forces the air along the tortuous path 44 forcing the particulates to collide against the shell 40 and inner duct 42. The inner duct 42 has a plurality of spaced openings 46 in the front of the duct 42 that are in communication with the filter media 14 through openings 48 in the back of the duct 42.

The intake 15 has an inlet 50 partially closed by a first baffle 52. The baffle defines a reduced opening 54 spaced from said inlet 50. Air containing particulates drawn into the inlet 50 by the blower 13 engages the outer shell 40 and the baffle 52 prior to entering inlet 50. The baffle 52 has a faceplate 56 and flanges 58 that define a first air flow path and a second air flow path adjacent the first air flow path wherein air containing particulate is forced to reverse direction (shown by the arrows in the drawings) before entering the inlet 50. The air and particulate entrained in the air also contact the faceplate 56 before entering the inlet 50. The faceplate 56 has an opening 60 that allows any particulate to drop through and not collect in the spark arrestor. The tortuous path 40 ends in a narrow path 62 with an opening 64 that allows any particulate to drop through and not collect in the spark arrestor. In this way, the spark arrestor 20 is self-cleaning.

The spark arrestor 20 intake 15 is further defined by first baffle 52 having flanges 58 partially closing inlet 50 and a second baffle 70 and a third baffle 72. Flanges 58 and the baffles 70 and 72 define a first airflow path. Second baffle 70 and the third baffle 72 define the inlet 50 and a second airflow path. The first airflow path is in communication with the second airflow path at a transition zone 75.

In the disclosed embodiment, the outer shell 40 and the duct 42 have a plurality of straight surfaces connected by corners to define the tortuous path 44.

Air is drawn into the collector through the intake 15. Sparks are carried by the airflow movement or under their own inertia from the generating process for example grinding where a shower of high velocity sparks are created from contact of the grinding disc to metal. The baffle plate 52 prevents any direct entry from sparks into the inlet 50.

Sparks are high energy particles that are heavier than air. They will not easily navigate sharp turns as created by the tortuous path 44. The tortuous path 44 has the effect of disrupting the spark energy bubble, breaking it into smaller pieces, and cooling it down or extinguishing it.

There are two destinations for the cooled sparks i.e. regular particles, along with the fume particles that are suspended in the air. First, they are conveyed through the inner duct 42 and into the filter compartment to be filtered out of the airstream by the filter media 14. Second, if they drop out of the airstream, they fall down out of the drop out slots provided so that they return to the facility floor.

The accumulation of particles within the spark arrestor 20 could ignite. Ignition could create a cloud of burning particulate in the airstream that would carry through to the filter media 14 and destroy the filters 14 and could cause significant damage. Therefore, the ability for the spark arrestor 20 to self-clean (by ensuring no particles remain to build up providing a fuel source) is a critical component of its ongoing operation and reduction of need for constant maintenance to clean it to keep it operative.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A horizontal elongated industrial air filter comprising:
an elongated housing having a top and opposed sides, a length, a width, and a height, said length being greater than said width or height, said housing having a filter section and an intake and an exhaust;
a filter media mounted within said housing, said filter media having an interior and an exterior said filter media being in operative communication with said intake;
a blower mounted adjacent to said filter media; said blower adapted to pull air into said intake, through said filters and push the air out of said exhaust;
reverse pulse pipes extending through said interiors of said filter media; said reverse pulse pipes being adapted to inject air through said filter from said interior to said exterior to remove accumulated particulate;
a hopper containment section extending adjacent and below said filter section, said hopper containment section having an open top in communication with said housing, sidewalls and a bottom wall; a plurality of spaced slots extending through said bottom wall; said hopper containment section adapted to receive particulate ejected from said filter media;
a vacuum channel operatively connected to said hopper containment section; said vacuum channel having at least one vacuum port; said vacuum channel being adapted to pull particulate in said hopper containment section through said slots into said vacuum channel upon the introduction of a vacuum to said vacuum channel.

2. The horizontal elongated industrial air filter of claim 1, further including nozzles mounted upon said reverse pulse pipes.

3. The horizontal elongated industrial air filter of claim 1, wherein said opposed sides of said housing have a first upper portion ending in an angled lower second portion.

4. The horizontal elongated industrial air filter of claim 1, wherein said sidewalls of said hopper containment section are angled with respect to said first upper portion of said sides of said housing.

5. The horizontal elongated industrial air filter of claim 3, wherein said sidewalls angle inwardly with respect to said first upper portion of said sides of said housing.

6. The horizontal elongated industrial air filter of claim 1, wherein said open top of said hopper containment section is partially closed by inwardly extending flanges.

7. The horizontal elongated industrial air filter of claims 1, wherein said filter media includes a plurality of cylindrical filter elements.

8. The horizontal elongated industrial air filter of claim 1, wherein said vacuum channel has a discharge port for the discharge of particulate.

9. The horizontal elongated industrial air filter of claim 1, further including a spark arrestor mounted adjacent said housing, said spark arrestor having an outer shell, an inlet and an inner duct, said outer shell being spaced from said inner duct to define a tortuous path;
wherein air containing particulates drawn into said inlet by said blower is forced along said tortuous path with said particulates colliding against said shell and inner duct.

10. The horizontal elongated industrial air filter of claim 9, wherein said outer shell and said duct are defined by a plurality of straight surfaces connected by corners.

11. The horizontal elongated industrial air filter of claim 9, wherein said inner duct has a plurality of spaced openings, said spaced openings being in communication with said filter media housing.

12. The horizontal elongated industrial air filter of claim 11, wherein said tortuous path ends in a narrower path, said narrower path providing an exit for particulate such that said spark arrestor is self-cleaning.

13. The horizontal elongated industrial air filter of claim 8, further including a baffle partially closing said inlet; said baffle defining a reduced opening spaced from said inlet,
wherein air containing particulates drawn into said inlet by said blower is forced to engage said outer shell and said baffle prior to entering said inlet.

14. The horizontal elongated industrial air filter of claim 13, wherein said baffle includes openings to allow particulate to exit said spark arrestor.

15. The horizontal elongated industrial air filter of claim 13, said baffle defines a first air flow path and a second air flow path adjacent said first air flow path;
wherein air containing particulate is forced to reverse direction before entering said inlet.

16. The horizontal elongated industrial air filter of claim 9, wherein said spark arrestor has an elongated outer body portion positioned adjacent said filter section.

17. The horizontal elongated industrial air filter of claim 9, wherein said spark arrestor inlet is defined by a first baffle partially closing said inlet, generally parallel second and third baffles, a first air flow path defined by said first baffle and said second and third baffles; a second air flow path defined by said second baffle and said third baffle, said first air flow path in communicating with said second air flow path at a transition zone, said transition zone positioned between said first, second third baffles.

18. The horizontal elongated industrial air filter of claim 9, wherein said first baffle has a body portion and opposed lips.

19. The horizontal elongated industrial air filter of claim 9, wherein said center duct has spaced openings in fluid communication with said filter media.

20. A horizontal elongated industrial air filter comprising:
an elongated housing having a top and opposed sides, a length, a width, and a height, said length being greater than said width or height, said housing having a filter section and an intake and an exhaust;
a blower mounted adjacent to said filter section; said blower adapted to pull air into said intake, through said filter section and push the air out of said exhaust;
reverse pulse pipes extending through said filter section;
a hopper containment section extending adjacent and below said filter section, said hopper containment section having an open top in communication with said housing, sidewalls and a bottom wall; a plurality of spaced slots extending through said bottom wall; said hopper containment section;
a vacuum channel operatively connected to said hopper containment section; said vacuum channel having at least one vacuum port; said vacuum channel being adapted to pull particulate in said hopper containment section through said slots into said vacuum channel upon the introduction of a vacuum to said vacuum channel;
a spark arrestor mounted adjacent said housing, said spark arrestor having an outer shell, an inlet and an inner duct, said outer shell being spaced from said inner duct to define a tortuous path;
wherein air containing particulates drawn into said inlet by said blower is forced along said tortuous path with said particulates colliding against said shell and inner duct.

21. A horizontal elongated industrial air filter of claim 21, further including filter media mounted within said housing, said filter media having an interior and an exterior said filter media being in operative communication with said intake; said reverse pulse pipes being adapted to inject air through said filter media from said interior to said exterior to remove accumulated particulate.

23. The horizontal elongated industrial air filter of claim 20, further including nozzles mounted upon said reverse pulse pipes.

24. The horizontal elongated industrial air filter of claim 20, wherein said opposed sides of said housing have a first upper portion ending in an angled lower second portion.

25. The horizontal elongated industrial air filter of claim 20, wherein said sidewalls of said hopper containment section are angled with respect to said first upper portion of said sides of said housing.

26. The horizontal elongated industrial air filter of claim 25, wherein said sidewalls angle inwardly with respect to said first upper portion of said sides of said housing.

27. The horizontal elongated industrial air filter of claim 20, wherein said open top of said hopper containment section is partially closed by inwardly extending flanges.

28. The horizontal elongated industrial air filter of claims 21, wherein said filter media includes a plurality of cylindrical filter elements.

29. The horizontal elongated industrial air filter of claim 20, wherein said vacuum channel has a discharge port for the discharge of particulate.

30. The horizontal elongated industrial air filter of claim 20, wherein said outer shell and said duct are defined by a plurality of straight surfaces connected by corners.

31. The horizontal elongated industrial air filter of claim 20, wherein said inner duct has a plurality of spaced openings, said spaced openings being in communication with said filter media housing.

32. The horizontal elongated industrial air filter of claim 31, wherein said tortuous path ends in a narrower path, said narrower path providing an exit for particulate such that said spark arrestor is self-cleaning.

33. The horizontal elongated industrial air filter of claim 20, further including a baffle partially closing said inlet; said baffle defining a reduced opening spaced from said inlet,
wherein air containing particulates drawn into said inlet by said blower is forced to engage said outer shell and said baffle prior to entering said inlet.

34. The horizontal elongated industrial air filter of claim 33, wherein said baffle includes openings to allow particulate to exit said spark arrestor.

35. The horizontal elongated industrial air filter of claim 33, said baffle defines a first air flow path and a second air flow path adjacent said first air flow path;
wherein air containing particulate is forced to reverse direction before entering said inlet.

36. The horizontal elongated industrial air filter of claim 20, wherein said spark arrestor has an elongated outer body portion positioned adjacent said filter section.

37. The horizontal elongated industrial air filter of claim 20, wherein said spark arrestor inlet is defined by a first baffle partially closing said inlet and generally parallel second and third baffles, a first airflow path defined by said first baffle and said second and third baffles; a second airflow path defined by said second baffle and said third baffle, said first air flow path in communication with said second air flow path at a transition zone, said transition zone positioned between said first and second baffles and said third baffle.

38. The horizontal elongated industrial air filter of claim 20, wherein said third baffle has a body portion and opposed lips.

39. The horizontal elongated industrial air filter of claim 20, wherein said center duct has spaced openings in fluid communication with said filter media.
